(19) United States
(12) Patent Application Publication
(10) Pub. No.: US 2018/0002085 A1
(43) Pub. Date: Jan. 4, 2018

(54) FOOD PACKAGING FILMS FROM LIGNIN AND METHODS OF MAKING THE SAME

(71) Applicant: EMPIRE TECHNOLOGY DEVELOPMENT LLC, Wilmington, DE (US)

(72) Inventor: Sivaraman Raghu, Chennai (IN)

(73) Assignee: EMPIRE TECHNOLOGY DEVELOPMENT LLC, Wilmington, DE (US)

(21) Appl. No.: 15/626,870

(22) Filed: Jun. 19, 2017

(30) Foreign Application Priority Data
Jun. 29, 2016 (IN) 201641022360

(51) Int. Cl. B65D 65/46; C08L 29/04; B65B 25/00; C08J 5/18; A23L 3/00; B65B 11/00

(52) U.S. Cl. CPC B65D 65/466; A23L 3/00; B65B 11/00; B65B 25/001; C08J 5/18; C08L 29/04; A23V 2002/00; C08J 2329/04; C08J 2497/00; C08L 2203/16; C08L 2205/03; C08L 2312/00; C08J 2403/00

(57) ABSTRACT

Provided herein are materials comprising a crosslinked polymer and a hydrophobic starch, wherein the crosslinked polymer comprises a first polymer and a second polymer and the first polymer comprises a lignin polymer or a salt thereof, and methods of use and preparation thereof.

### CLAIM OF PRIORITY

This application claims benefit of the filing date of Indian Application No. 201641022360 filed Jun. 29, 2016, the disclosure of which is hereby incorporated by reference.

### BACKGROUND

Materials for food packaging must fulfill a number of stringent requirements including being non-toxic, having good shear strength, good barrier properties, stability to harsh environments, and provide an antimicrobial environment. It is additionally advantageous if the materials are biodegradable and derived from natural resources.

### SUMMARY

The present technology relates to materials derived from lignocellulosic biomass, which may be biodegradable on composting. Because lignocellulosic biomass represents the largest renewable resource for chemical feedstocks and energy, there has been considerable effort expended on utilizing them in biorefinement to produce bioderived fuels and value added chemicals. However, the byproduct of biorefinement, lignin, which constitutes about 15-40 percent of the biomass, still remains underutilized. The use of lignin in materials such as food packaging films may provide a non-toxic, biodegradable material that also possesses other beneficial properties needed for food preservation and shelf life.

In one aspect, the present technology provides a material that includes a hydrophobic starch and a crosslinked polymer, wherein the crosslinked polymer includes a first polymer and a second polymer. In some embodiments, the first polymer may be a lignin polymer or a salt thereof. In some embodiments, the second polymer may include polyvinyl alcohol (PVA) and/or include one or more polymerized monomers selected from the group consisting of vinyl acetate, styrene, acrylonitrile, butadiene, hydroxyethyl acrylate, butyl acrylate, propylene, ethylene oxide, and propylene oxide. In some embodiments, the first polymer and the second polymer are crosslinked with an aldehyde crosslinking agent. In some embodiments, the material may be a film. In another aspect, the present technology provides a method of packaging or storing a food including wrapping or covering the food with the material.

In another aspect, the present technology provides a method of preparing a material including a hydrophobic starch and a crosslinked polymer, wherein the crosslinked polymer includes a first polymer and a second polymer, and the method includes mixing the hydrophobic starch, the first polymer, the second polymer, and a crosslinking agent to form a mixture. In some embodiments, the first polymer may be a lignin polymer or a salt thereof. In some embodiments, the second polymer may include polyvinyl alcohol and/or include one or more polymerized monomers selected from the group consisting of vinyl acetate, styrene, acrylonitrile, butadiene, hydroxyethyl acrylate, butyl acrylate, propylene, ethylene oxide, and propylene oxide. In some embodiments, the first polymer and the second polymer are crosslinked with an aldehyde crosslinking agent. In some embodiments, the method includes heating the mixture at a temperature and time sufficient to crosslink the first polymer and the second polymer with the crosslinking agent.

In another aspect, the present technology provides a method of packaging or storing a food, including wrapping or covering the food with a material that includes a crosslinked polymer, wherein the crosslinked polymer includes a first polymer and a second polymer. In some embodiments, the first polymer may be a lignin polymer or a salt thereof. In some embodiments, the second polymer may include polyvinyl alcohol and/or include one or more polymerized monomers selected from the group consisting of vinyl acetate, styrene, acrylonitrile, butadiene, hydroxyethyl acrylate, butyl acrylate, propylene, ethylene oxide, and propylene oxide.

### DETAILED DESCRIPTION

The material described herein that includes lignin may be biodegradable on composting. In some embodiments, the material may be non-toxic. The material may have good shear strength and good barrier properties (e.g., towards moisture and oxygen). The material may not allow the build-up of ethylene gas. In some embodiments, the material may be stable to harsh environments such as acids and UV light. In some embodiments, the material may be sealable and/or machinable. The material may provide an antimicrobial environment.

In one aspect, the present technology provides a material that includes a hydrophobic starch and a crosslinked polymer, wherein the crosslinked polymer includes a first polymer and a second polymer. The first polymer may be a lignin.

In some embodiments, the lignin may be a salt. In some embodiments, the first polymer may a lignin polymer or salt thereof. The lignin may derived from lignocellulosic biomass. In some embodiments, the lignin may be derived from lignocellulosic biomass as a byproduct of biorefinement. In some embodiments, the lignin may be a byproduct of paper making. In some embodiments, the lignin may be soda lignin (i.e., sodium lignin salt) or lignosulfonate (i.e., sulfonated lignin).

The lignin polymer or salt thereof may have various molecular weights depending on the lignocellulosic biomass source and process from which it is derived. In some embodiments, the lignin polymer or salt thereof may have a number average molecular weight (Mₙ) from about 450 g/mol to 20,000 g/mol. In some embodiments, the lignin polymer or salt thereof may have a Mₙ from about 2000 g/mol to 15,000 g/mol. In some embodiments, the lignin polymer or salt thereof may have a Mₙ from about 3000 g/mol to 15,000 g/mol. In some embodiments, the lignin polymer or salt thereof may have a Mₙ from about 4000 g/mol to 10,000 g/mol. In some embodiments, the lignin polymer or salt thereof may have a Mₙ from about 2000 g/mol to 9000 g/mol. In some embodiments, the lignin polymer or salt thereof may have a Mₙ from about 500 g/mol to 3500 g/mol. In some embodiments, the lignin polymer or salt thereof may have a Mₙ from about 490 g/mol to 3100 g/mol. In some embodiments, the lignin polymer or salt thereof may have a Mₙ from about 490 g/mol to 1700 g/mol. In some embodiments, the lignin polymer or salt thereof may have a weight average molecular weight (M_{w}) from about 450 g/mol to 85,000 g/mol. In some embodiments, the lignin polymer or salt thereof may have a M_{w} from about 13,000 g/mol to 55,000 g/mol. In some embodiments, the lignin polymer or salt thereof may have a M_{w} from about 15,000 g/mol to 30,000 g/mol. In some embodiments, the lignin polymer or salt thereof may have a M_{w} from about 25,000 g/mol to 80,000 g/mol. In some embodiments, the lignin polymer or salt thereof may have a M_{w} from about 30,000 g/mol to 60,000 g/mol. In some embodiments, the lignin polymer or salt thereof may have a M_{w} from about 5000 g/mol to 25,000 g/mol. In some embodiments, the lignin polymer or salt thereof may have a M_{w} from about 5500 g/mol to 15,000 g/mol. In some embodiments, the lignin polymer or salt thereof may have a M_{w} from about 490 g/mol to 14,000 g/mol. In some embodiments, the lignin polymer or salt thereof may have a M_{w} from about 490 g/mol to 2500 g/mol. In some embodiments, the lignin polymer or salt thereof may have a polydispersity index (PDI) from about 1 to 10. In some embodiments, the lignin polymer or salt thereof may have a PDI from about 3 to 9. In some embodiments, the lignin polymer or salt thereof may have a PDI from about 3 to 6. In some embodiments, the lignin polymer or salt thereof may have a PDI from about 1 to 4.5. In some embodiments, the lignin polymer or salt thereof may have a PDI from about 1.5 to 4. In some embodiments, the lignin polymer or salt thereof may have a PDI from about 1 to 1.5.

In some embodiments, the second polymer may include polyvinyl alcohol and/or include one or more polymerized monomers selected from the group consisting of vinyl acetate, styrene, acrylonitrile, butadiene, hydroxyethyl acrylate, butyl acrylate, propylene, ethylene oxide, and propylene oxide. In some embodiments, the second polymer may include one or more polymerized monomers selected from the group consisting of styrene, acrylonitrile, and butadiene. In some embodiments, the second polymer may be include polymerized monomers of vinyl acetate. In some embodiments, the polymerized monomers of vinyl acetate may be hydrolyzed. In some embodiments, the second polymer may include polyvinyl alcohol.

In some embodiments, the material may include starch or a starch derivative. In some embodiments, the starch derivative may be a hydrophobic starch. In some embodiments, the starch may be derivatized from various base starches including granular starches, native, converted, or derivatized. Such starches include, but are not limited to, those derived from any plant source including wheat, rice, sago, tapioca, waxy maize, corn, potato, sorghum, and high amylose starch such as high amylose corn. In some embodiments, the starch may be derivatized from starch flours. Also included are the conversion products derived from any of the former bases such as, for example, dextrins, fluidity or thin boiling starches, oxidized starches, and derivatized starches such as cationic, anionic, amphoteric, non-ionic and crosslinked. In some embodiments, the hydrophobic starch may include one or more functional groups, including but not limited to, ester, ether, urethane, and combinations thereof. In some embodiments, the functional groups may be selected from ester, ether, or urethane. In some embodiments, the hydrophobic starch may include one or more alkyl, alkylene, alkene, or alkenylene groups. In some embodiments, the alkyl, alkylene, alkene, or alkenylene groups may include 1 to 30 carbon atoms. In some embodiments, the alkyl, alkylene, alkene, or alkenylene groups may include 6 to 25 carbon atoms. In some embodiments the alkyl, alkylene, alkene, or alkenylene groups may include 8 to 20 carbon atoms. In some embodiments, the hydrophobic starch may include one or more C₈-C₂₀ alkyl groups. In some embodiments, the hydrophobic starch may be a starch esterified with one or more C₈-C₂₀ alkyl groups. Non-limiting examples of hydrophobic starches include stearic acid ester, oleic acid ester, octyl ether, and octadecyl urethane.

In some embodiments, the ratio of the first polymer and the second polymer may be about 1:20 to 20:1 by weight. In some embodiments, the ratio of the first polymer and the second polymer may be about 1:10 to 10:1 by weight. In some embodiments, the ratio of the first polymer and the second polymer may be about 1:5 to 1:10 by weight. In some embodiments, the ratio of the first polymer and the second polymer may be about 1:1 to 1:10 by weight. In some embodiments, the ratio of the first polymer and the second polymer may be about 1:2 to 1:6 by weight. In some embodiments, the ratio of the first polymer and the hydrophobic starch may be about 1:20 to 20:1 by weight. In some embodiments, the ratio of the first polymer and the hydrophobic starch may be about 1:10 to 10:1 by weight. In some embodiments, the ratio of the first polymer and the hydrophobic starch may be about 1:5 to 5:1 by weight. In some embodiments, the ratio of the first polymer and the hydrophobic starch may be about 1:2 to 2:1 by weight. In some embodiments, the ratio of the first polymer, the second polymer, and the hydrophobic starch may be about 1:4:1 by weight.

In some embodiments, the material may include one or more antioxidants. In some embodiments, the antioxidant may be selected from the group consisting of tocopherol, carotene, lycopene, lutein, astaxanthin, polyphenol, and combinations thereof. In some embodiments, the carotene may be α-carotene, β-carotene, or a combination thereof. In some embodiments, the polyphenol may be one or more of ferrulic acid, gallic acid, catechin, or epicatechin. In some embodiments, the antioxidant may include tocopherol. In some embodiments, the tocopherol may be α-tocopherol, β-tocopherol, γ-tocopherol, δ-tocopherol, or combinations thereof.

The material may include from about 1% to 20% antioxidant by weight of the first polymer. In some embodiments, the material may include from about 1% to 10% antioxidant by weight of the first polymer. In some embodiments, the material may include from about 1% to 7% antioxidant by weight of the first polymer. In some embodiments, the material may include from about 1% to 5% antioxidant by weight of the first polymer. In some embodiments, the material may include from about 0.1% to 10% antioxidant of the total weight of the material. In some embodiments, the material may include from about 0.1% to 5% antioxidant of the total weight of the material. In some embodiments, the material may include from about 0.2% to 3% antioxidant of the total weight of the material. In some embodiments, the material may include from about 0.3% to 1.5% antioxidant of the total weight of the material. In some embodiments, the material may include from about 0.5% to 1% antioxidant of the total weight of the material. In some embodiments, the material may include from about 1% to 10% antioxidant by weight of the first polymer or about 0.1% to 5% of the total weight of the material. In some embodiments, the material may include about 5% antioxidant by weight of the first polymer or about 0.8% of the total weight of the material.

In some embodiments, the material may include an one or more ethylene absorbers. In some embodiments, the ethylene absorber may include aluminosilicate. In some embodiments, the aluminasilicate may be a zeolite. In some embodiments, the ethylene absorber may include potassium permanganate and alumina. In some embodiments, the ethylene absorber may include hydrated potassium permanganate and zeolite. In some embodiments, the ethylene absorber may include an acid; a hygroscopic water carrier; and a hypochlorite salt. In some embodiments, the hypochlorite salt may be calcium hypochlorite, sodium hypochlorite, potassium hypochlorite, magnesium hypochlorite, or a combination thereof. The acid may be any acid that will react with the hypochlorite to produce the hypochlorous acid. In some embodiments, the acid may be a carboxylic acid. In some embodiments the carboxylic acid may be oxalic acid, acetic acid, formic acid, benzoic acid, citric acid, and combinations thereof.

The material may include from about 1% to 30% ethylene absorber by weight of the first polymer. In some embodiments, the material may include from about 1% to 20% ethylene absorber by weight of the first polymer. In some embodiments, the material may include from about 5% to 15% ethylene absorber by weight of the first polymer. In some embodiments, the material may include from about 7% to 11% ethylene absorber by weight of the first polymer. In some embodiments, the material may include from about 0.1% to 10% ethylene absorber of the total weight of the material. In some embodiments, the material may include from about 0.1% to 7% ethylene absorber of the total weight of the material. In some embodiments, the material may include from about 0.5% to 5% ethylene absorber of the total weight of the material. In some embodiments, the material may include from about 1% to 2% ethylene absorber of the total weight of the material. In some embodiments, the material may include from about 1% to 20% ethylene absorber by weight of the first polymer or about 0.1% to 10% of the total weight of the material. In some embodiments, the material may include about 10% ethylene absorber by weight of the first polymer or about 1.6% of the total weight of the material.

In some embodiments, the first polymer and the second polymer may be crosslinked with an aldehyde crosslinking agent. In some embodiments, the crosslinking agent may be selected from glyceraldehyde, glutaraldehyde, glyoxal, formaldehyde, benzaldehyde, glucose, acetaldehyde, or combinations thereof. In some embodiments, the crosslinking agent may include glyceraldehyde.

The material may include from about 1% to 20% crosslinking agent by weight of the first polymer. In some embodiments, the material may include from about 1% to 10% crosslinking agent by weight of the first polymer. In some embodiments, the material may include from about 1% to 7% crosslinking agent by weight of the first polymer. In some embodiments, the material may include from about 1% to 5% crosslinking agent by weight of the first polymer. In some embodiments, the material may include from about 0.1% to 10% crosslinking agent of the total weight of the material. In some embodiments, the material may include from about 0.1% to 5% crosslinking agent of the total weight of the material. In some embodiments, the material may include from about 0.2% to 3% crosslinking agent of the total weight of the material. In some embodiments, the material may include from about 0.3% to 1.5% crosslinking agent of the total weight of the material. In some embodiments, the material may include from about 0.5% to 1% crosslinking agent of the total weight of the material. In some embodiments, the material may include from about 1% to 10% crosslinking agent by weight of the first polymer or about 0.1% to 5% of the total weight of the material. In some embodiments, the material may include about 5% crosslinking agent by weight of the first polymer or about 0.8% of the total weight of the material.

In some embodiments, the material may include a plasticizer. In some embodiments, the plasticizer may be a di- or poly-hydroxy hydrocarbon or ester of phthalic acid (i.e., phthalate). In some embodiments, the plasticizer may be a natural-based plasticizer such as an epoxidized triglyceride vegetable oil from soybean oil, linseed oil, castor-oil, sunflower oil, and fatty acid esters. In some embodiments, the plasticizer may include dioctyl phthalate, dibutyl phthalate, dioctyl adipate, dibutyl sebacate, esters of pentaerithritol, diethyleneglycol, dibenzoate, acetylricinoleic, tricresyl phosphate, triphenyl phospate, epoxidated soy bean oil, epoxidated linseed oil, bisphenol-based epoxy resins, acetyltributyl citrate, acetyltreoctyl citrate, trialkyl trimallitate, tetra-n-octyl, pyromellitate, polypropylene adipate, or combinations thereof. In some embodiments, the plasticizer may include ethylene glycol, diethylene glycol, triethylene glycol, tetraethylene glycol and polyethylene glycol, propylene glycol, sorbitol, mannitol and xylitol; fatty acids; monosaccharides (e.g., glucose, mannose, fructose, sucrose); ethanolamine; urea; triethanolamine; vegetable oils; lecithin; waxes; amino acids; or combinations thereof. In some embodiments, the plasticizer may include glycerine (i.e., glycerol), 1,3-dihydroxypropane, 1,3- or 1,4-dihydroxybutane, 1,3-dihydroxyisobutan, pentaerythritol. In some embodiments, the plasticizer may include glycerine.

The material may include from about 1% to 20% plasticizer by weight of the first polymer. In some embodiments, the material may include from about 1% to 10% plasticizer by weight of the first polymer. In some embodiments, the material may include from about 1% to 7% plasticizer by weight of the first polymer. In some embodiments, the material may include from about 1% to 6% plasticizer by weight of the first polymer. In some embodiments, the material may include from about 0.1% to 10% plasticizer of the total weight of the material. In some embodiments, the material may include from about 0.1% to 5% plasticizer of the total weight of the material. In some embodiments, the material may include from about 0.2% to 3% plasticizer of the total weight of the material. In some embodiments, the material may include from about 0.5% to 1.5% plasticizer of the total weight of the material. In some embodiments, the material may include from about 1% to 10% plasticizer by weight of the first polymer or about 0.1% to 5% of the total weight of the material. In some embodiments, the material may include about 6% plasticizer by weight of the first polymer or about 1% of the total weight of the material.

In some embodiments, the material may include plant antimicrobial peptides (AMPs). The AMPs may be isolated from roots, seeds, flowers, stems, and leaves of a wide variety of species that have activities towards phytopathogens, as well as against bacteria pathogenic to humans. In some embodiments, the AMPs may be derived from wheat flour, thyme, and/or oregano. In some embodiments, the AMPs may include thionin, thymol, carvacrol, or a combination thereof. In some embodiments, the material may include dyes, pigments, or a combination thereof. In some embodiments, the material may include a solvent. In some embodiments, the solvent may be water or alcohol. In some embodiments, the alcohol may be ethanol. In some embodiments, the solvent may be water.

In some embodiments, the material may be a film. In some embodiments, the film may have a thickness from about 10 μm to 5 mm. In some embodiments, the film may have a thickness from about 10 μm to 1000 μm. In some embodiments, the film may have a thickness from about 10 μm to 100 μm.

The material may have an ultimate tensile strength greater than about 20 MPa. In some embodiments, the material may have an ultimate tensile strength greater than about 25 MPa. In some embodiments, the material may have an ultimate tensile strength greater than about 30 MPa. In some embodiments, the material may have an ultimate tensile strength from about 32 MPa to 45 MPa. In some embodiments, the material may have an ultimate tensile strength from about 36 MPa to 40 MPa. In some embodiments, the material may have an elongation greater than about 150%. In some embodiments, the material may have an elongation greater than about 200%. In some embodiments, the material may have an elongation greater than about 230%. In some embodiments, the material may have an elongation greater than about 250%. In some embodiments, the material may have an elongation greater than about 260%. In some embodiments, the material may have an elongation from about 270% to 350%. In some embodiments, the material may have an elongation from about 280% to 320%.

The material may have an oxygen transmission less than about 7 cm³/m² dPa. In some embodiments, the material may have an oxygen transmission less than about 6 cm³/m² dPa. In some embodiments, the material may have an oxygen transmission less than about 4 cm³/m² dPa. In some embodiments, the material may have an oxygen transmission less than about 3 cm³/m² dPa. In some embodiments, the material may have an oxygen transmission less than about 2 cm³/m² dPa. In some embodiments, the material may have an oxygen transmission from about 0.5 cm³/m² dPa to 3 cm³/m² dPa. In some embodiments, the material may have an oxygen transmission from about 1 cm³/m² dPa to 2 cm³/m² dPa.

The material may have a CO₂ transmission less than about 6 cm³/m² dPa. In some embodiments, the material may have a CO₂ transmission less than about 5 cm³/m² dPa. In some embodiments, the material may have a CO₂ transmission less than about 4 cm³/m² dPa. In some embodiments, the material may have a CO₂ transmission less than about 3 cm³/m² dPa. In some embodiments, the material may have a CO₂ transmission less than about 2 cm³/m² dPa. In some embodiments, the material may have a CO₂ transmission from about 0.5 cm³/m² dPa to 3.5 cm³/m² dPa. In some embodiments, the material may have a CO₂ transmission from about 1 cm³/m² dPa to 2.5 cm³/m² dPa.

In some embodiments, the material may be in the form of a bag. In some embodiments, the material may be in the form of a container.

In another aspect, the present technology provides a method of packaging or storing a food including wrapping or covering the food with the material. The material may be stored and dispensed using any known plastic wrap dispenser.

In another aspect, the present technology provides a method of packaging or storing a food, including wrapping or covering the food with a material that includes a crosslinked polymer, wherein the crosslinked polymer includes a first polymer and a second polymer. In some embodiments, the material may include one or more additives selected from antioxidants, ethylene absorbers, plasticizers, AMPs, and solvent(s) as described herein.

In another aspect, the present technology provides a method of preparing a material including a hydrophobic starch and a crosslinked polymer, wherein the crosslinked polymer includes a first polymer and a second polymer, and the method includes mixing the hydrophobic starch, the first polymer, the second polymer, and a crosslinking agent to form a mixture.

The first polymer may include lignin as described herein. The second polymer may include polyvinyl alcohol or one or more polymerized monomers selected from the group consisting of vinyl acetate, styrene, acrylonitrile, butadiene, hydroxyethyl acrylate, butyl acrylate, propylene, ethylene oxide, and propylene oxide as described herein. In some embodiments, the first polymer and the second polymer may be crosslinked with an aldehyde crosslinking agent as described herein. In some embodiments, the material may include one or more additives selected from antioxidants, ethylene absorbers, plasticizers, AMPs, and solvent(s) as described herein. In some embodiments, the mixture may include a solvent. In some embodiments, the solvent may be water. In some embodiments, the solvent may be an alcohol such as ethanol.

In some embodiments, the method may include heating the mixture at a temperature and time sufficient to crosslink the first polymer and the second polymer with the crosslinking agent. In some embodiments, the method may include heating the mixture from about 50° C. to 150° C. In some embodiments, the method may include heating the mixture from about 60° C. to 120° C. In some embodiments, the method may include heating the mixture from about 80° C. to 100° C. In some embodiments, the method may include heating the mixture from about 5 minutes to 60 minutes. In some embodiments, the method may include heating the mixture about 10 minutes to 45 minutes. In some embodiments, the method may include heating the mixture from about 15 minutes to 25 minutes. In some embodiments, the method may include heating the mixture from about 50° C. to 150° C. for about 5 minutes to 60 minutes. In some embodiments, the method may include heating the mixture from about 80° C. to 100° C. for about 15 minutes to 25 minutes.

In some embodiments, the method may include freeze drying the mixture to produce a freeze dried mixture. In some embodiments, the freeze dried mixture may be melt extruded to form the material. In some embodiments, the extrusion may be conducted at a temperature of about 175 to 300° C. In some embodiments, the extrusion may be conducted at a temperature of about 200 to 250° C. In some embodiments, the extrusion may be conducted at a temperature of about 220 to 230° C.

In some embodiments, the method may include casting the mixture on a drying surface to form the material. In some embodiments, the mixture may be dried about 10 to 60 hours. In some embodiments, the mixture may be dried about 12 to 48 hours. In some embodiments, the mixture may be dried about 24 hours.

In some embodiments, the material may be a film as described herein.

### EXAMPLES

The following examples are intended to more specifically illustrate the present material according to various embodiments described above. These examples should in no way be construed as limiting the scope of the present technology.

### Example 1

### Synthesis of Lignin-PVA-HS Film

Soda lignin was acquired as a byproduct from a paper milling company. To a flask equipped with a stir bar, 1 g of the soda lignin, 4 g of polyvinyl alcohol (PVA), 1 g of hydrophobic starch (HS), and 20 mL of water were added. The mixture was heated to 80° C. To the heated mixture 50 mg of glyceraldehyde was added followed by 60 mg of glycerol. The mixture was kept at 80-100° C. for 20-30 minutes under constant stirring and cooled to room temperature. The material was extruded at 220° C.

### Example 2

### Synthesis of Lignin-PVA-HS Film With Antioxidant and Ethylene Absorber

Soda lignin was acquired as a byproduct from a paper milling company. To a flask equipped with a stir bar, 1 g of the soda lignin, 4 g of polyvinyl alcohol (PVA), 1 g of hydrophobic starch (HS), and 20 mL of water were added. The mixture was heated to 80° C. To the heated mixture 50 mg of glyceraldehyde was added followed by 60 mg of glycerol. The mixture was kept at 80-100° C. for 20-30 minutes under constant stirring and cooled to room temperature. After cooling, 100 mg of powdered zeolite and 50 mg of mixed tocopherols were added and the mixture was stirred. The material was poured on to a polyvinylchloride (PVC) surface and allowed to dry over 24 hours.

The following terms are used herein, the definitions of which are provided for guidance.

For the purposes of this disclosure and unless otherwise specified, “a” or “an” means “one or more.”

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% or up to plus or minus 5% of the stated value.

“Alkyl” refers to monovalent straight or branched saturated aliphatic hydrocarbyl groups. In some embodiments, an alkyl has from 1 to 30 carbon atoms, from 5 to 25 carbon atoms, from 8 to 20 carbon atoms, from 1 to 10 carbon atoms, or from 1 to 6 carbon atoms. This term includes, by way of example, linear and branched hydrocarbyl groups such as methyl (CH₃—, or Me), ethyl (CH₃CH₂—, or Et), n-propyl (CH₃CH₂CH₂—, or n-Pr), isopropyl ((CH₃)₂CH—, or i-Pr), n-butyl (CH₃CH₂CH₂CH₂—, or n-Bu), isobutyl ((CH₃)₂CHCH₂—, or i-Bu), sec-butyl ((CH₃)(CH₃CH₂)CH—, or s-Bu), t-butyl ((CH₃)₃C—, or t-Bu), n-pentyl (CH₃CH₂CH₂CH₂CH₂—), and neopentyl ((CH₃)₃CCH₂—). C, alkyl refers to an alkyl group having x number of carbon atoms.

“Alkenyl” refers to monovalent straight or branched hydrocarbyl groups having at least 1, such as 1 or 2 sites, of vinyl (>C═C<) unsaturation. In some embodiments, an alkenyl has from 2 to 30 carbon atoms, from 5 to 25 carbon atoms, from 8 to 20 carbon atoms, from 2 to 10 carbon atoms, or from 2 to 6 carbon atoms. Such groups are exemplified, for example, by vinyl, allyl, and but-3-en-1-yl. Included within this term are the cis and trans isomers or mixtures of these isomers. Cₓ alkenyl refers to an alkenyl group having x number of carbon atoms.

Groups described herein having two or more points of attachment (i.e., divalent, trivalent, or polyvalent) within the compound of the present technology are designated by use of the suffix, “ene.” For example, divalent alkyl groups are alkylene groups, divalent alkenyl groups are alkenylene groups, and so forth. Nonlimiting examples include methylene (—CH₂)—, ethylene (—CH₂—CH₂—), ethenylene (—CH═CH—), butylene (—CH₂—CH₂—CH₂—CH₂—), and butenylene (—CH═CH—CH₂—CH₂—). Substituted groups having a single point of attachment to the compound of the present technology are not referred to using the “ene” designation. Thus, e.g., chloroethyl is not referred to herein as chloroethylene.

“Aldehyde” refers to CH₂O or alkyl or alkenyl substituted with CHO, wherein CHO represents

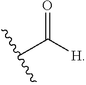

The term “ester” as used herein refers to —COOR¹ groups. R¹ is a substituted or unsubstituted alkyl, cycloalkyl, alkenyl, alkynyl, aryl, aralkyl, heterocyclylalkyl, or heterocyclyl group.

Urethane groups include N- and O-urethane groups, i.e., —NR²C(O)OR³ and —OC(O)NR²R³groups, respectively. R² and R³ are independently a substituted or unsubstituted alkyl, alkenyl, alkynyl, cycloalkyl, aryl, aralkyl, heterocyclylalkyl, or heterocyclyl group.

The term “ether” as used herein refers to —R⁴CR⁵— groups. R⁴ and R⁵ are independently substituted or unsubstituted alkyl, cycloalkyl, alkenyl, alkynyl, aryl, aralkyl, heterocyclylalkyl, or heterocyclyl groups. R⁴ and R⁵ may be the same or different.

### ILLUSTRATIVE EMBODIMENTS

Reference is made in the following to a number of illustrative embodiments of the subject matter described herein. The following embodiments describe illustrative embodiments that may include various features, characteristics, and advantages of the subject matter as presently described. Accordingly, the following embodiments should not be considered as being comprehensive of all of the possible embodiments or otherwise limit the scope of the methods, materials and compositions described herein.

In one aspect, the present technology provides a material including a hydrophobic starch and a crosslinked polymer, wherein the crosslinked polymer includes a first polymer and a second polymer; wherein: the first polymer includes a lignin polymer or a salt thereof; and the second polymer includes polyvinyl alcohol and/or includes one or more polymerized monomers selected from the group consisting of vinyl acetate, styrene, acrylonitrile, butadiene, hydroxyethyl acrylate, butyl acrylate, propylene, ethylene oxide, and propylene oxide. In some embodiments, the second polymer includes polyvinyl alcohol. In some embodiments, the ratio of the first polymer and the second polymer may be about 1:10 to 10:1. In some embodiments, the ratio of the first polymer and the hydrophobic starch may be about 1:10 to 10:1. In some embodiments, the ratio of the first polymer, the second polymer, and the hydrophobic starch may be about 1:4:1. In some embodiments, the material includes an antioxidant, an ethylene absorber, a plasticizer, or a combination of any two or more thereof. In some embodiments, the material may further include an antioxidant. In some embodiments, the antioxidant is selected from the group consisting of tocopherol, carotene, lycopene, lutein, astaxanthin, polyphenol, and combinations thereof. In some embodiments, the antioxidant includes tocopherol. In some embodiments, the antioxidant comprises from about 1% to 10% by weight of the first polymer or about 0.1% to 5% of the total weight of the material. In some embodiments, the antioxidant comprises about 5% by weight of the first polymer or about 0.8% of the total weight of the material. In some embodiments, the material further includes an ethylene absorber. In some embodiments, the material may further include an ethylene absorber. In some embodiments, the ethylene absorber may include aluminosilicate. In some embodiments, the aluminosilicate may include a zeolite. In some embodiments, the ethylene absorber may comprise from about 1% to 20% by weight of the first polymer or about 0.1% to 10% of the total weight of the material. In some embodiments, the ethylene absorber may comprise about 10% by weight of the first polymer or about 1.6% of the total weight of the material. In some embodiments, the material further includes a plasticizer. In some embodiments, the plasticizer includes glycerine. In some embodiments, the plasticizer comprises from about 1% to 10% by weight of the first polymer or about 0.1% to 5% of the total weight of the material. In some embodiments, the plasticizer comprises about 6% by weight of the first polymer or about 1% of the total weight of the material. In some embodiments, the first polymer and the second polymer are crosslinked with an aldehyde crosslinking agent. In some embodiments, the crosslinking agent is selected from the group consisting of glyceraldehyde, glutaraldehyde, glyoxal, formaldehyde, benzaldehyde, glucose, acetaldehyde, and combinations thereof. In some embodiments, the crosslinking agent includes glyceraldehyde. In some embodiments, the crosslinking agent comprises from about 1% to 10% by weight of the first polymer or about 0.1% to 5% of the total weight of the material. In some embodiments, the crosslinking agent comprises about 5% by weight of the first polymer or about 0.8% of the total weight of the material. In some embodiments, the material may be a film. In some embodiments, the film may have a thickness of from about 10 μm to 5 mm. In some embodiments, the material may have an ultimate tensile strength greater than about 30 MPa. In some embodiments, the material may have an ultimate tensile strength from about 32 MPa to 45 MPa. In some embodiments, the material may have an ultimate tensile strength from about 36 MPa to 40 MPa. In some embodiments, the material may have an elongation greater than about 260%. In some embodiments, the material may have an elongation from about 270% to 350%. In some embodiments, the material may have an elongation from about 280% to 320%. In some embodiments, the material may have an oxygen transmission less than about 6 cm³/m² dPa. In some embodiments, the material may have an oxygen transmission from about 0.5 cm³/m² dPa to 3 cm³/m² dPa. In some embodiments, the material may have an oxygen transmission from about 1 cm³/m² dPa to 2 cm³/m² dPa. In some embodiments, the material may have a CO₂ transmission less than about 5 cm³/m² dPa. In some embodiments, the material may have a CO₂ transmission from about 0.5 cm³/m² dPa to 3.5 cm³/m² dPa. In some embodiments, the material may have a CO₂ transmission from about 1 cm³/m² dPa to 2.5 cm³/m² dPa. In some embodiments, the material may be in the form of a bag. In some embodiments, the material may be in the form of a container.

In one aspect, the present technology provides a method of packaging or storing a food, including wrapping or covering the food with the material.

In another aspect, the present technology provides a method of packaging or storing a food, including wrapping or covering the food with a material including a crosslinked polymer, wherein the crosslinked polymer includes a first polymer and a second polymer; wherein: the first polymer includes a lignin polymer or a salt thereof; and the second polymer includes polyvinyl alcohol and/or includes one or more polymerized monomers selected from the group consisting of vinyl acetate, styrene, acrylonitrile, butadiene, hydroxyethyl acrylate, butyl acrylate, propylene, ethylene oxide, and propylene oxide. In some embodiments, the second polymer includes polyvinyl alcohol. In some embodiments, the ratio of the first polymer and the second polymer may be about 1:10 to 10:1. In some embodiments, the ratio of the first polymer and the second polymer may be about 1:4. In some embodiments, the material may further include an antioxidant. In some embodiments, the antioxidant is selected from the group consisting of tocopherol, carotene, lycopene, lutein, astaxanthin, polyphenol, and combinations thereof. In some embodiments, the antioxidant includes tocopherol. In some embodiments, the antioxidant comprises from about 1% to 10% by weight of the first polymer or about 0.1% to 5% of the total weight of the material. In some embodiments, the antioxidant comprises about 5% by weight of the first polymer or about 0.8% of the total weight of the material. In some embodiments, the material further includes an ethylene absorber. In some embodiments, the ethylene absorber includes aluminosilicate. In some embodiments, the aluminosilicate may include a zeolite. In some embodiments, the ethylene absorber comprises from about 1% to 20% by weight of the first polymer or about 0.1% to 10% of the total weight of the material. In some embodiments, the ethylene absorber comprises about 10% by weight of the first polymer or about 1.6% of the total weight of the material. In some embodiments, the material further includes a plasticizer. In some embodiments, the plasticizer includes glycerine. In some embodiments, the plasticizer comprises from about 1% to 10% by weight of the first polymer or about 0.1% to 5% of the total weight of the material. In some embodiments, the plasticizer comprises about 6% by weight of the first polymer or about 1% of the total weight of the material. In some embodiments, the first polymer and the second polymer are crosslinked with an aldehyde crosslinking agent. In some embodiments, the crosslinking agent is selected from the group consisting of glyceraldehyde, glutaraldehyde, glyoxal, formaldehyde, benzaldehyde, glucose, acetaldehyde, and combinations thereof. In some embodiments, the crosslinking agent includes glyceraldehyde. In some embodiments, the crosslinking agent comprises from about 1% to 10% by weight of the first polymer or about 0.1% to 5% of the total weight of the material. In some embodiments, the crosslinking agent comprises about 5% by weight of the first polymer or about 0.8% of the total weight of the material. In some embodiments, the material may be a film. In some embodiments, the film may have a thickness of from about 10 μm to 5 mm. In some embodiments, the material may have an ultimate tensile strength greater than about 30 MPa. In some embodiments, the material may have an ultimate tensile strength from about 32 MPa to about 45 MPa. In some embodiments, the material may have an ultimate tensile strength from about 36 MPa to 40 MPa. In some embodiments, the material may have an elongation greater than about 260%. In some embodiments, the material may have an elongation from about 270% to 350%. In some embodiments, the material may have an elongation from about 280% to 320%. In some embodiments, the material may have an oxygen transmission less than about 6 cm³/m² dPa. In some embodiments, the material may have an oxygen transmission from about 0.5 cm³/m² dPa to 3 cm³/m² dPa. In some embodiments, the material may have an oxygen transmission from about 1 cm³/m² dPa to 2 cm³/m² dPa. In some embodiments, the material may have a CO₂ transmission less than about 5 cm³/m² dPa. In some embodiments, the material may have a CO₂ transmission from about 0.5 cm³/m² dPa to 3.5 cm³/m² dPa. In some embodiments, the material may have a CO₂ transmission from about 1 cm³/m² dPa to 2.5 cm³/m² dPa. In some embodiments, the material may be in the form of a bag. In some embodiments, the material may be in the form of a container.

In another aspect, the present technology provides a method of preparing a material including a hydrophobic starch and a crosslinked polymer, wherein the crosslinked polymer includes a first polymer and a second polymer; wherein: the first polymer includes a lignin polymer or a salt thereof; and the second polymer includes polyvinyl alcohol and/or includes one or more polymerized monomers selected from the group consisting of vinyl acetate, styrene, acrylonitrile, butadiene, hydroxyethyl acrylate, butyl acrylate, propylene, ethylene oxide, propylene oxide; the method including mixing the hydrophobic starch, the first polymer, the second polymer, and a crosslinking agent to form a mixture. In some embodiments, the mixture further includes water. In some embodiments, the mixture may include an antioxidant, an ethylene absorber, a plasticizer, or a combination of any two or more thereof. In some embodiments, the ratio of the first polymer and the second polymer may be about 1:10 to 10:1. In some embodiments, the ratio of the first polymer and the hydrophobic starch may be about 1:10 to 10:1. In some embodiments, the ratio of the first polymer, the second polymer, and the hydrophobic starch may be about 1:4:1. In some embodiments, the material may further include an antioxidant. In some embodiments, the antioxidant is selected from the group consisting of tocopherol, carotene, lycopene, lutein, astaxanthin, polyphenol, and combinations thereof. In some embodiments, the antioxidant includes tocopherol. In some embodiments, the antioxidant comprises from about 1% to 10% by weight of the first polymer or about 0.1% to 5% of the total weight of the material. In some embodiments, the antioxidant comprises about 5% by weight of the first polymer or about 0.8% of the total weight of the material. In some embodiments, the material further includes an ethylene absorber. In some embodiments, the ethylene absorber includes aluminosilicate. In some embodiments, the aluminosilicate may include a zeolite. In some embodiments, the ethylene absorber comprises from about 1% to 20% by weight of the first polymer or about 0.1% to 10% of the total weight of the material. In some embodiments, the ethylene absorber comprises about 10% by weight of the first polymer or about 1.6% of the total weight of the material. In some embodiments, the material further includes a plasticizer. In some embodiments, the plasticizer includes glycerine. In some embodiments, the plasticizer comprises from about 1% to 10% by weight of the first polymer or about 0.1% to 5% of the total weight of the material. In some embodiments, the plasticizer comprises about 6% by weight of the first polymer or about 1% of the total weight of the material. In some embodiments, the method may further include heating the mixture at a temperature and time sufficient to crosslink the first polymer and the second polymer with the crosslinking agent. In some embodiments, the temperature may be from about 50° C. to 150° C. In some embodiments, the temperature may be from about 80° C. to 100° C. In some embodiments, the time may be from about 5 minutes to 60 minutes. In some embodiments, the time may be from about 10 minutes to 45 minutes. In some embodiments, the time may be from about 15 minutes to 25 minutes. In some embodiments, the crosslinking agent is selected from the group consisting of glyceraldehyde, glutaraldehyde, glyoxal, formaldehyde, benzaldehyde, glucose, acetaldehyde, and combinations thereof. In some embodiments, the crosslinking agent includes glyceraldehyde. In some embodiments, the crosslinking agent comprises from about 1% to 10% by weight of the first polymer or about 0.1% to 5% of the total weight of the material. In some embodiments, the crosslinking agent comprises about 5% by weight of the first polymer or about 0.8% of the total weight of the material. In some embodiments, the method include freeze drying the mixture to produce a freeze dried mixture. In some embodiments, the method may further include melt extruding the freeze dried mixture to form the material. In some embodiments, the extrusion may be conducted at a temperature of about 220 to 230° C. In some embodiments, the method may include casting the mixture on a drying surface to form the material. In some embodiments, the material may be a film. In some embodiments, the film may have a thickness of from about 10 μm to 5 mm. In some embodiments, the material may have an ultimate tensile strength greater than about 30 MPa. In some embodiments, the material may have an ultimate tensile strength from about 32 MPa to 45 MPa. In some embodiments, the material may have an ultimate tensile strength from about 36 MPa to 40 MPa. In some embodiments, the material may have an elongation greater than about 260%. In some embodiments, the material may have an elongation from about 270% to 350%. In some embodiments, the material may have an elongation from about 280% to 320%. In some embodiments, the material may have an oxygen transmission less than about 6 cm³/m² dPa. In some embodiments, the material may have an oxygen transmission from about 0.5 cm³/m² dPa to 3 cm³/m² dPa. In some embodiments, the material may have an oxygen transmission from about 1 cm³/m² dPa to 2 cm³/m² dPa. In some embodiments, the material may have a CO₂ transmission less than about 5 cm³/m² dPa. In some embodiments, the material may have a CO₂ transmission from about 0.5 cm³/m² dPa to 3.5 cm³/m² dPa. In some embodiments, the material may have a CO₂ transmission from about 1 cm³/m² dPa to 2.5 cm³/m² dPa.

1. A material comprising a hydrophobic starch and a crosslinked polymer, wherein the crosslinked polymer comprises a first polymer and a second polymer;
wherein:
the first polymer comprises a lignin polymer or a salt thereof; and
the second polymer comprises polyvinyl alcohol or comprises one or more polymerized monomers selected from the group consisting of vinyl acetate, styrene, acrylonitrile, butadiene, hydroxyethyl acrylate, butyl acrylate, propylene, ethylene oxide, and propylene oxide.

2. The material of claim 1, wherein the ratio of the first polymer and the second polymer is about 1:20 to 20:1 by weight.

3. The material of claim 1, wherein the ratio of the first polymer and the hydrophobic starch is about 1:20 to 20:1 by weight.

4. The material of claim 1, wherein the ratio of the first polymer, the second polymer, and the hydrophobic starch is about 1:4:1.

5. The material of claim 1, further comprising an antioxidant, wherein the antioxidant is selected from the group consisting of tocopherol, carotene, lycopene, lutein, astaxanthin, polyphenol, and combinations thereof.

6. The material of claim 5, wherein the antioxidant comprises from about 1% to 20% by weight of the first polymer or about 0.1% to 10% of the total weight of the material.

7. The material of claim 1, further comprising an ethylene absorber, wherein the ethylene absorber comprises aluminosilicate, and wherein the aluminosilicate comprises a zeolite.

8. The material of claim 7, wherein the ethylene absorber comprises from about 1% to 30% by weight of the first polymer or about 0.1% to 10% of the total weight of the material.

9. The material of claim 1, wherein the first polymer and the second polymer are crosslinked with an aldehyde crosslinking agent, wherein the crosslinking agent is selected from the group consisting of glyceraldehyde, glutaraldehyde, glyoxal, formaldehyde, benzaldehyde, glucose, acetaldehyde, and combinations thereof.

10. The material of claim 9, wherein the crosslinking agent comprises from about 1% to 20% by weight of the first polymer or about 0.1% to 10% of the total weight of the material.

11. The material of claim 1, further comprising a plasticizer, wherein the plasticizer comprises glycerine.

12. The material of claim 11, wherein the plasticizer comprises from about 1% to 20% by weight of the first polymer or about 0.1% to 10% of the total weight of the material.

13. The material of claim 1, wherein the material is a film, wherein the film has a thickness of from about 10 μm to 5 mm.

14. The material of claim 1, wherein the material has an ultimate tensile strength from about 20 MPa to 45 MPa.

15. The material of claim 1, wherein the material has an elongation from about 150% to 350%.

16. The material of claim 1, wherein the material has an oxygen transmission from about 0.5 cm³/m² dPa to about 7 cm³/m² dPa.

17. The material of claim 1, wherein the material has a CO₂ transmission from about 0.5 cm³/m² dPa to 6 cm³/m² dPa.

18. A method of packaging or storing a food, comprising wrapping or covering the food with the material of claim 1.

19. A method of preparing a material comprising a hydrophobic starch and a crosslinked polymer, wherein the crosslinked polymer comprises a first polymer and a second polymer;
wherein:
the first polymer comprises a lignin polymer or a salt thereof; and
the second polymer comprises polyvinyl alcohol or comprises one or more polymerized monomers selected from the group consisting of vinyl acetate, styrene, acrylonitrile, butadiene, hydroxyethyl acrylate, butyl acrylate, propylene, ethylene oxide, propylene oxide;
the method comprising mixing the hydrophobic starch, the first polymer, the second polymer, and a crosslinking agent to form a mixture.

20. The method of claim 19, wherein the mixture further comprises a solvent, wherein the solvent comprises an alcohol or water.

21. The method of any claim 19, further comprising heating the mixture at a temperature and time sufficient to crosslink the first polymer and the second polymer with the crosslinking agent.

22. The method of claim 21, wherein the temperature is from about 50° C. to 150° C. and the time is about 5 minutes to 60 minutes.

23. The method of claim 19, wherein the crosslinking agent is an aldehyde crosslinking agent, and wherein the crosslinking agent is selected from the group consisting of glyceraldehyde, glutaraldehyde, glyoxal, formaldehyde, benzaldehyde, glucose, acetaldehyde, and combinations thereof.

24. The method of claim 19, further comprising freeze drying the mixture to produce a freeze dried mixture.

25. The method of claim 24, further comprising melt extruding the freeze dried mixture to form the material, wherein the melt extrusion is conducted at a temperature of about 175° C. to 300° C.

26. The method of claim 19, further comprising casting the mixture on a drying surface to form the material.

27. The method of claim 19, wherein the material is a film, wherein the film has a thickness of from about 10 μm to 5 mm.
